(19) United States
(12) Patent Application Publication
(10) Pub. No.: US 2014/0165683 A1
(43) Pub. Date: Jun. 19, 2014

(54) COMPOSITIONS AND METHODS FOR SUSTAINED RELEASE OF AGRICULTURAL MACRONUTRIENTS

(71) Applicant: Sri Lanka Institute of Nanotechnology (PVT) Ltd., Malwana (LK)

(72) Inventors: Nilwala Kottegoda, Malwana (LK); D.A.S. Siriwardhana, Malwana (LK); W.M.G.I. Priyadarshana, Malwana (LK); Chanaka Sandaruwan, Malwana (LK); D.A.D. Madushanka, Malwana (LK); U.A. Rathnayake, Malwana (LK); Sunanda Gunasekara, Malwana (LK); Damayanthi Dahanayake, Malwana (LK); Ajith DeAlwis, Malwana (LK); Asurusinghe Kumarasinghe, Malwana (LK); Veranja Karunaratne, Malwana (LK); Gehan Amaratunga, Malwana (LK)

(73) Assignee: Sri Lanka Institute of Nanotechnology (PVT) Ltd., Malwana (LK)

(21) Appl. No.: 14/184,784

(22) Filed: Feb. 20, 2014

Related U.S. Application Data
(63) Continuation-in-part of application No. 13/707,985, filed on Dec. 7, 2012, now Pat. No. 8,696,784.
Application No. 13/707,985 is a continuation-in-part of application No. 12/794,741, filed on Jun. 5, 2010, now Pat. No. 8,361,185.

(51) Int. Cl. C05B 17/00

(52) U.S. Cl. CPC C05B 17/00
USPC 71/29

(57) ABSTRACT

A solid fertilizer composition wherein a nitrogen-containing macronutrient is adsorbed on the surface of hydroxyapatite phosphate nanoparticles and wherein the ratio of the nitrogen-containing macronutrient to the hydroxyapatite phosphate is between 1:1 and 10:1. In certain embodiments, said solid fertilizer composition slowly releases the nitrogen-containing macronutrient to soil.

### CROSS-REFERENCE TO RELATED APPLICATIONS

This application is a continuation-in-part of U.S. application Ser. No. 13/707,985 filed Dec. 7, 2012, which in turn is a continuation-in-part of U.S. application Ser. No. 12/794,741 filed Jun. 5, 2010 (U.S. application Ser. No. 12/794,741 issued on Jan. 29, 2013 as U.S. Pat. No. 8,361,185). The contents of those applications arc incorporated herein in their entireties by reference.

### FIELD OF THE INVENTION

This invention relates to macronutrient adsorbed hydroxyapatite phosphate (“HAP” or “HA”) nanoparticle compositions and methods of preparing those compositions, some of which will slowly release agricultural nutrients over an extended period of time.

### BACKGROUND

Micronutrients and macronutrients are essential for plant growth.

As defined herein, micronutrients required in small amounts for plant growth are boron (B), chlorine (Cl), manganese (Mn), iron (Fe), zinc (Zn), copper (Cu), molybdenum (Mo), and selenium (Se).

As defined herein, primary macronutrients are nitrogen (N), phosphorous (P), and potassium (K) while calcium (Ca), magnesium (Mg), and sulfur (S) are secondary macronutrients. All six macronutrients are important for plant growth and are used by plants in relatively large amounts.

Macronutrient-containing fertilizers can help aid plant growth. To begin, nitrogen, phosphorus, and potassium (NPK), which are required in large amounts for plant growth, are not always adequately available in natural soils to support the sustained growth of plants. Additionally, production of crops removes these vital macronutrients from the soil. Key macronutrients, such as nitrogen, which is essential to plant growth and particularly important for economic crops such as tea, will be readily removed from the soil by the production of crops. For example, the production of 1,000 kg of tea leaves (dry weight) removes up to 100 kg of nitrogen from soil. Ideally, this removed nitrogen should be replenished by external application of fertilizer to support plant growth. Generally, macronutrients in fertilizers can be applied to the soil as a solid in the form of a powder, pellets, or as a spray. As such, supplying nitrogen macronutrient through an external fertilizer is critical in preventing the decline of productivity and profitability due to degradation and aging of tea plants. (Kamau et al. Field Crops Research 1, 108. 60-70, 2008).

A major problem with traditional fertilization methods is low Nitrogen Use Efficiency (NUE). Nitrogen Use Efficiency is a measure of crop production per unit of nitrogen fertilizer input. For example, a study in Japan (Yamada et al, Journal of Water and Environmental Technology, 7, 4, 331-340, 2009) reported that, of a large amount of nitrogen fertilizer applied to tea, only 12% of the nitrogen input was taken up fay the plant and the rest, was discharged to the environment. Such a low NUE can occur because an excessive amount of nitrogen, up to 70%, is lost when using conventional fertilizers due to leaching, emissions, and long-term incorporation by soil microorganisms. Attempts to increase the NUE so far have had little success. Accordingly, solutions are needed to provide slow release macronutrient formulations for plant growth applications that help improve the low NUE by crops.

Slow release fertilizers have the potential to improve NUE and prevent environmental problems. Slow release fertilizers oiler improved release efficiency and quality as the nutrients are released over time, thus providing sufficient quantities of macronutrients as required for higher crop yields. In addition, slow release fertilizers, result in reduced environmental damage from leaching of nitrogen into water and emissions as gasses, compared to conventional water soluble fertilizers. Because of their potential to solve the problems stated above, there is an increased interest, in developing slow release fertilizers that release nitrogen to plants over time.

### SUMMARY

A nitrogen-containing macronutrient is adsorbed on MA nanoparticles and used as a fertilizer. Stable, solid compositions were formulated through flash drying in a ratio of up to 10:1 of nitrogen-containing macronutrient: HA. In some embodiments, during flash drying, a urea-HA nanodispersion is sprayed onto a hot surface where the temperature of the surface is maintained between about 70-150° C. In other embodiments, during flash drying, a urea-HA nanodispersion is sprayed through a hot, countercurrent air flow, wherein the temperature of the countercurrent air flow is between about 70° C.-150° C. In still further embodiments, one or more of various other nitrogen-containing macronutrients are in a nanodispersion with HA and are flash dried using one of the above two flash-drying techniques.

In the flash drying process of the present invention, the time required to dry the droplets is a traction of a second. This rapid drying time is due to the very high surface area of the sprayed urea-HA nanoparticle or other nitrogen-containing macronutrient-HA droplets. In conventional oven drying processes, drying time is much longer than that of the flash drying process of the present invention, thus allowing enough time for a phase separation of the metastable nanodispersion in those conventional processes, thus preventing the formation of higher ratio (e.g., 6:1) stable, solid urea-HA nanocomposites or other stable, solid nitrogen-containing macronutrient-HA nanocomposites. The flash drying process of the present invention, however, impedes the phase separation of urea from urea-HA nanocomposite (or, in other embodiments, the nitrogen-containing macronutrient from the nitrogen-containing macronutrient-HA nanocomposite) and allows for the formation of stable, solid urea-HA nanocomposites (or, in other embodiments, nitrogen-containing macronutrient-HA nanocomposites) with higher urea-HA ratios (or, in other embodiments, higher nitrogen-containing macronutrient-HA ratios) (e.g., ratios up to between about 6:1 and 10:1).

Certain embodiments of the macronutrient adsorbed HA nanoparticles disclosed herein, when applied to aqueous and terrestrial environments, slowly release the nitrogen-containing macronutrient to the soil. The soil medium acts as a conduit for providing the transport of the nitrogen-containing macronutrient to the roots of the plant.

### BRIEF DESCRIPTION OF FIGURES

FIG. 1: Flow diagram for the synthesis of a (6:1) urea-HA nanocomposite.

FIG. 2(a): SEM image of HA nanoparticles as synthesized by the template synthesis method.

FIG. 2(b): SEM image of urea-HA nanoparticles after two hours of synthesis by template synthesis method.

FIG. 3(a): SEM image of urea-HA (6:1) spray dried powder.

FIG. 3(b): SEM image of urea-HA (6:1) spray dried powder.

FIG. 4: TEM image of the directionally attached nanobeads having formed into nanochain-like particles.

FIG. 5: TEM image of the internal structure of the resulting compound, showing a layering pattern on the nanobeads.

FIG. 6: XPS spectrum for N 1s core level.

FIG. 7: XPS spectrum for Ca 2p core level.

FIG. 8: XPS spectrum for P 2p core level.

FIG. 9(a): XPS spectrum for O 1s core level with urea as the reference.

FIG. 9(b); XPS spectrum for O 1s core level with HA as the reference.

FIG. 10: Accelerated water dissolution setup.

FIG. 11: Release behavior comparison for urea, (1:1) urea-HA oven dried powder, (6:1) urea-HA spray dried powder, (6:1) urea-HA spray dried pellets in water at room temperature.

FIG. 12; Release behavior comparison for urea, urea-HA (1:1), urea-HA (6:1 K urea-HA (8:1), and urea-HA (10:1) spray dried pellets in water at room temperature.

FIG. 13; Chart showing the average number of tillers for treatments T1-T10.

FIG. 14: (mart showing the average plant height at the end of 14 weeks after emergence for treatments T1-T10.

FIG. 15: Chart showing the average number of panicles per plant for treatments T1-T10.

FIG. 16: Chart showing the average panicle length for treatments T1-T10.

FIG. 17: Chart showing the average filled grain % for treatments T1-T10.

FIG. 18: Chart showing the average unfilled grain % for treatment T1-T10.

FIG. 19: Chart showing the average thousand grain weight for treatments T1-T10.

### DETAILED DESCRIPTION

As defined herein, a slow release of macronutrients provides the plant with nutrients gradually over an extended period of time. As described herein in further detail, such an extended period of time can be up to three months. Soils applied with slow release fertilizer that contain macronutrients will require fewer applications of such fertilizer. Use of a slow release fertilizer leads to higher efficiency of macronutrient release compared to conventional fast release fertilizers.

Adsorption, as defined herein, refers to any means that forms a reversible complex between the nitrogen-containing macronutrient compound and hydroxyapatite phosphate nanoparticles. These include covalent bonds, electrostatic bonds. Van der Waals bonds, hydrogen bonds, and metal-ligand interactions. Any nitrogen-containing substance that can deliver nitrate or nitrite to the plant can be used as the macronutrient for adsorption onto the HA nanoparticles. Examples of such nitrogen-containing substances include, but are not limited to, urea, thiourea, amides, posyamines, ammonia, and alginates.

As defined herein, basal fertilizer is fertilizer applied to soil during the soil preparation. Seeds are distributed into plowed soil and planted two weeks after basal fertilizer is applied to the soil.

A fertilizer top dressing, as defined herein, is fertilizer applied after seedlings have emerged from seeds buried in soil. Fertilizer top dressings can be applied at two weeks intervals after seedling emergence.

### Overview of Manufacture and Morphology of Flash-Dried Nitrogen-Containing Macronutrient-HA Nanoparticle Composite

Described herein is a solid fertilizer formulation (e.g., powder, granule, or pellet) with nitrogen content up to 40% that, after application to the soil, can slowly release its nitrogen over a period of up to three months.

Structural morphology of the HA-nanoparticles described herein indicates an initial formation of bead-like HA nanoparticles that grow into rod-like nanostructures. This growth pattern suggests that one face of the bead-like HA nanoparticle is more highly energetic than the other faces of the hexagonal unit cell, thus leading to directional growth along one orientation. This directional growth may occur through the PO₄²⁻ terminating plane. This results in a nanobead-chain-like structure leading to rod-like morphology. The directional growth is interrupted or delayed in the presence of spacer molecules such as amines and amides in the medium due to the adsorption of these spacer molecules onto the nanobeads through the reactive functional groups available in HA.

According to the methods described herein, prior to drying, HA-nitrogen-containing macronutrient nanoparticles can be obtained as a stable aqueous dispersion. Flash drying methods that allow for up to about a 10:1 ratio of nitrogen-containing macronutrient compound; HA are described further herein. After drying, the HA-nitrogen-containing macronutrient nanoparticles are obtained as a white solid powder which subsequently can be converted to pellets, solid chips, or granules. The chips, granules, powder, and/or pellets can be used as slow-release macronutrient formulations.

### EXAMPLE 1

### Creation of a Solid, Flash-Dried Composition with a Ratio of Urea Macronutrient: HA of about 6:1

Ca(OH)₂ (9.645 kg) was dissolved in water (75 L), and urea (75 kg) was added. The suspension was then mixed (stirred at 800 rpm) for 1 hour. H₃PO₄ (85% w/w, 5.050 L) was diluted in 25 L of water to prepare the acid solution required for the synthesis. The diluted H₃PO₄ solution was then sprayed on to the Ca(OH)₂/urea suspension at a rate of 715 ml/min. The H₃PO₄ spray addition takes place in a closed vat, and the H₃PO₄ is simply sprayed onto the top surface of the Ca(OH)₂/urea suspension that is being mixed in the closed vat vessel.

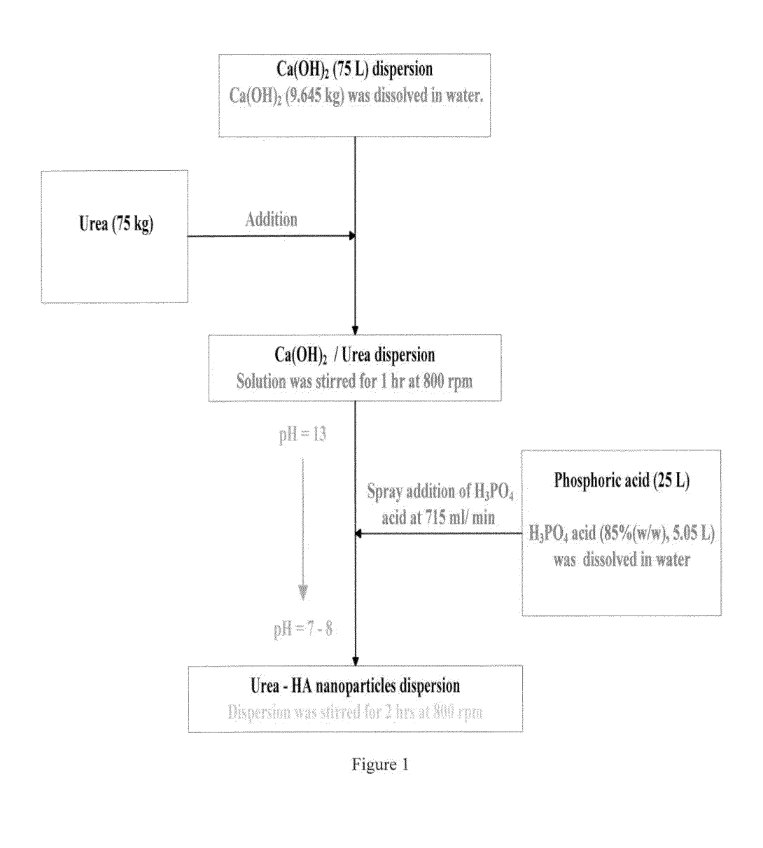

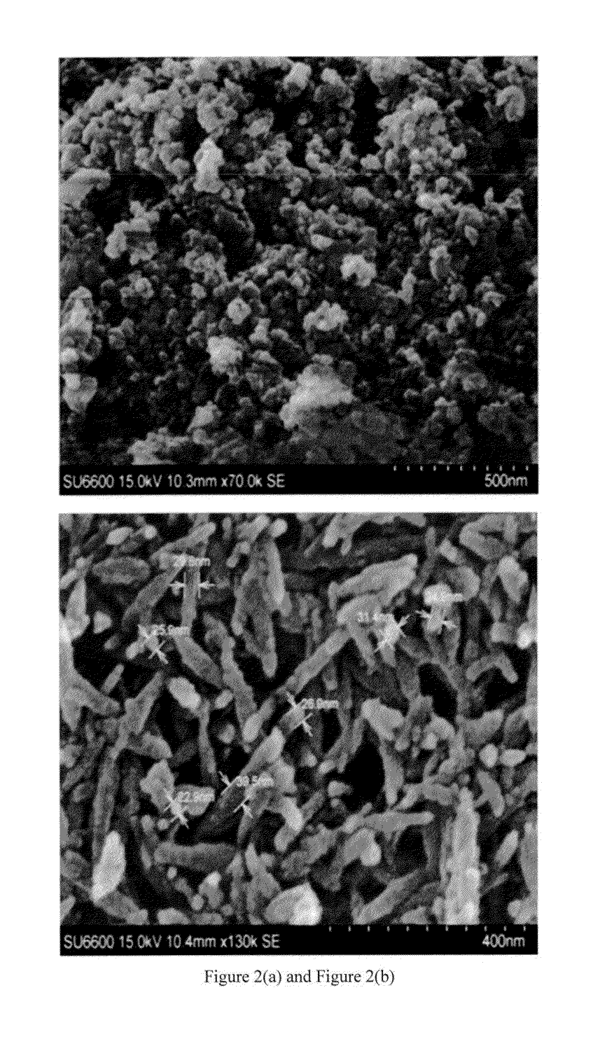

A urea-HA dispersion was formed. The morphology of the urea-HA nanoparticles is shown in FIG. 2(a). The urea-HA dispersion was then mixed (stirred at 800 rpm) for further 2 hrs. FIG. 2(b) shows the directionally attached nanobeads forming nanorods of urea-HA. A diagrammatic depiction of this synthesis process is given in FIG. 1.

The resulting urea-HA dispersion was then flash-dried using either of the following two methods:
1. Hot Surface Spray Technique:
   The liquid urea-HA nanodispersion created in the above process was sprayed onto a hot non-stick (teflon) surface where the temperature of the surface was maintained at 100° C. As used in this application, a hot, non-stick surface is any surface sufficiently hot to flash dry the liquid urea-HA nanodispersion, hut not hot enough to decompose the resulting solid composition. The temperature of the surface may range between about 70° C.-110° C. The surface was then scraped to obtain a solid powder composition.
2. Countercurrent Hot Air Flow Technique:
   The liquid urea-HA nanodispersion created in the above process was sprayed into a hot countercurrent air flow where the temperature of the air flow was maintained at 100° C. As used in this application, a hot countercurrent air flow is any countercurrent air flow sufficiently hot to flash dry the liquid urea-HA nanodispersion, but not hot enough to decompose the resulting solid composition. The temperature of the countercurrent air flow may range between about 70° C.-150° C. The resulting powder was collected.
      After this flash-drying process, the resulting urea-HA nanocomposite powder formulation can be pelletized.

The same process carried out above was also used to create flash-dried urea-HA nanocomposites with ratios of about 8:1 and about 10:1, and other ratios between 6:1 and 10:1. To generate those higher ratios, the molar ratios of Ca(OH)₂, H₃PO₄, and urea were modified to match the desired urea-HA ratio.

### EXAMPLE 2

### Creation of a Solid, Flash-Dried Composition with a Ratio of Nitrogen-Containing Macronutrient: HA of about 6:1

In this example, the same process carried out above uses nitrogen-containing macronutrients other than urea to create flash-dried nitrogen-containing macronutrient-HA nanocomposites. For example, in place of the urea used in Example 1, one or more of thiourea; ammonia; nitrides, amides, such as proteins, amino acids, compost or animal waste extracts such as ammonium urate or uric acid salts: chitosan; or alginates are used in the creation of a flash dried nitrogen-containing macronutrient; HA composition. Specifically, with reference to the nitrogen-containing macronutrients listed above in Example 2, it is anticipated that the flash drying process will yield flash-dried thiourea-HA, ammonia-HA, nitride-HA, protein-HA, amino acid-HA, ammonium urate-HA, uric acid-HA, chitosan-HA, or aliginate-HA nanocomposites in about a 6:1 ratio of macronutrient: HA.

### Characterization of the Resulting Compound of Example 1

As shown in SEM images (FIGS. 2(a) and 2(b)), a bead-like morphology which after time (2 hours as shown in FIG. 2(b)) transitions through directional growth into a bead-chain-like morphology. Average particle diameter of die resulting bead-chain-like nanoparticles is ˜30 nm with a particle length of ˜150 nm. The slow directional growth is observable since urea molecules are bound to HA nanoparticles thus delaying the directional growth process.

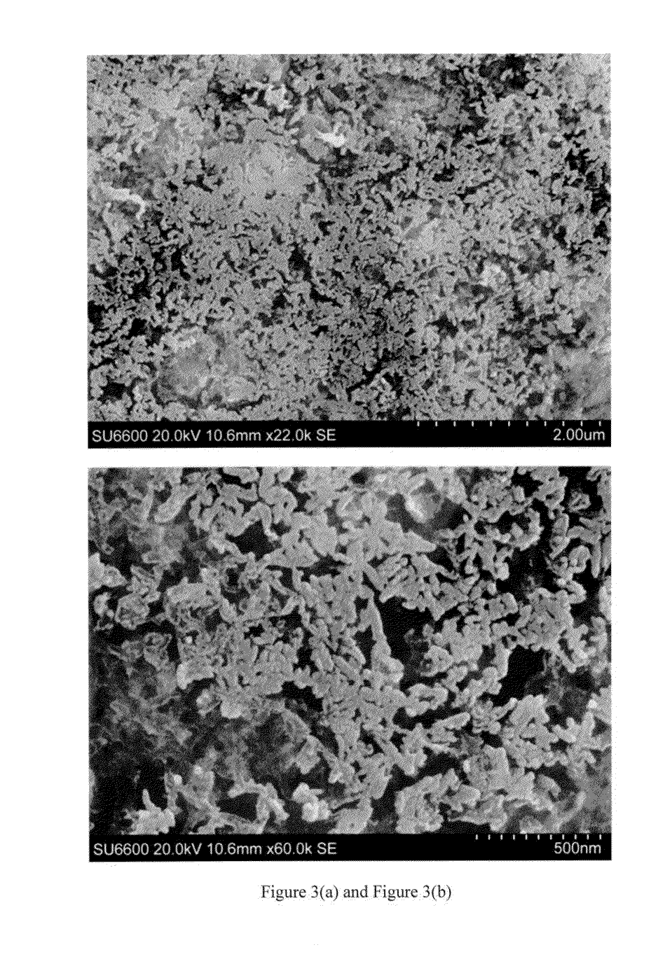

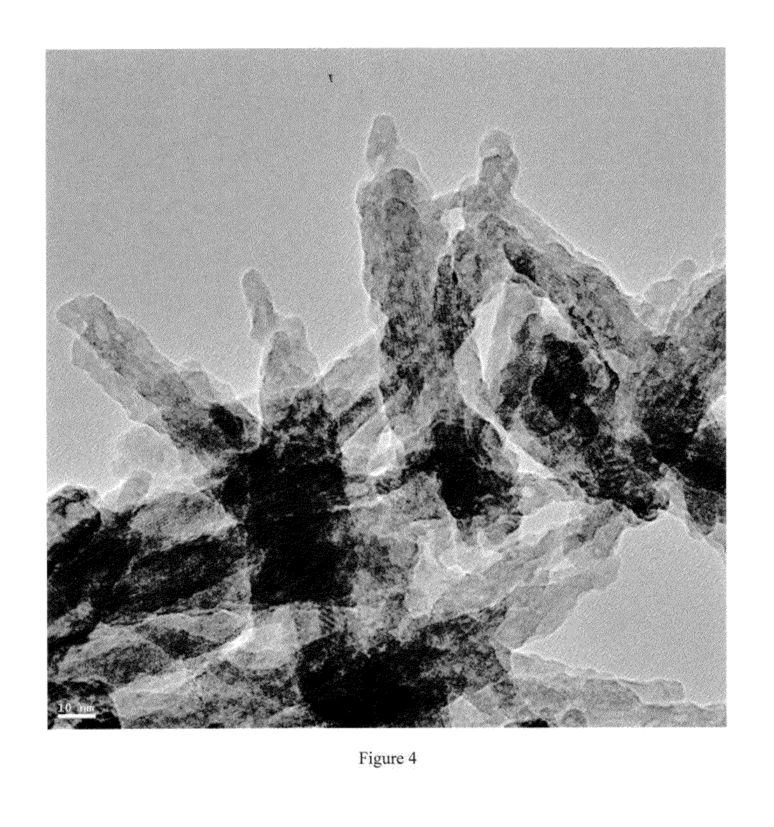

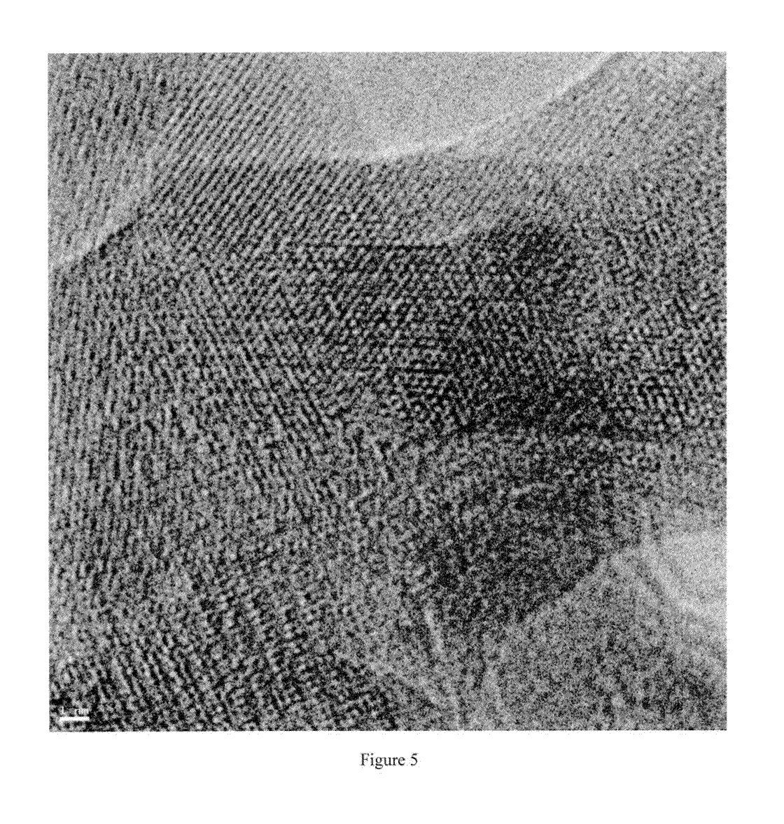

FIGS. 3(a) and 3(b) represent SEM images of the flash-dried urea-HA powder. The morphology, characterized by directionally attached beads which, together, have created a nanochain-like structure (˜20 nm in width at the two ends and ˜150 nm in length), is clearly observed in high resolution electron microscopy images shown in FIGS. 4 and 5. FIG. 4 shows a TEM image of the directionally attached nanobeads after having formed nanochain-like nanoparticles. FIG. 5 shows a TEM image of the internal structure of the resulting compound, showing a layering pattern on the nanobeads.

Uniform particle size distribution and morphology were observed by TEM and SEM analysis throughout the nanoeomposite, confirming the formation of a plant nutrient composition with urea: HAP in a ratio of 6:1. No phase separation (i.e., no separation of the nanocomposite into its constituent parts) was observed by electron microscopic analysis. Furthermore, in the uniform composition of urea; HAP ratio of 6:1, the nitrogen percentage was about 40% and the Ca:P ratio was about 1.66, as evidenced by the elemental analysis carried out in randomly selected samples by Kjeldhal analysis and energy dispersive X-ray analysis, respectively.

The unique structural features of the bead-chain-like urea: HA nanoparticles allow a nanocomposite with a high N content of up to 40% to be synthesized. Surprisingly and unexpectedly, flash drying allows the nanoeomposite to remain stable as a solid, even with a urea: HA ratio as high as 10:1. Previous drying methods only allowed for stable, solid nanocomposites with urea: HA ratios of about 1:1. Phase separation would occur when trying to generate solid urea: HA nanocomposites for ratios higher than 1:1 when using traditional drying processes, such as an oven-drying process. The Ca:P ratio of 1.66 was maintained in the composite with a urea: HA nanoparticle ratio of about 6:1.

After storage for three weeks in normal room temperature and humidity conditions (temperatures between approximately 18° C. and 25° C.; humidity levels between 40% and 60%), the percentage of N in the 6:1 urea-HA nanoeomposite remained at approximately 40% by weight, suggesting that there is no decomposition of the resulting nanocomposite under normal storage conditions.

BET surface area analysis gives an indication of the amount of surface area of a material available for molecular adsorption. When the surface of a material is modified/coated with another material/surface modifier, the available surface area for adsorption is reduced, thus indicating the successful modification, of a given surface.

BET surface area analysis conducted on the (6:1) urea: HA nanocomposite prepared above resulted in a BET surface area of 1.83 g m⁻². In comparison, the BET surface area analysis for HA nanoparticles which were synthesized by a coprecipitation method using Ca(OH)₂ and orthophosphoric acid (in the absence of any modifiers such as urea) was 81.07 g m⁻². Additionally, the BET surface area analysis for a urea-HA nanocomposite (1:1) formulation was 58.07 g m⁻². These results suggest that the nanocomposite has reached a very high loading capacity at urea: HA nanoparticle ratio of about 6:1.

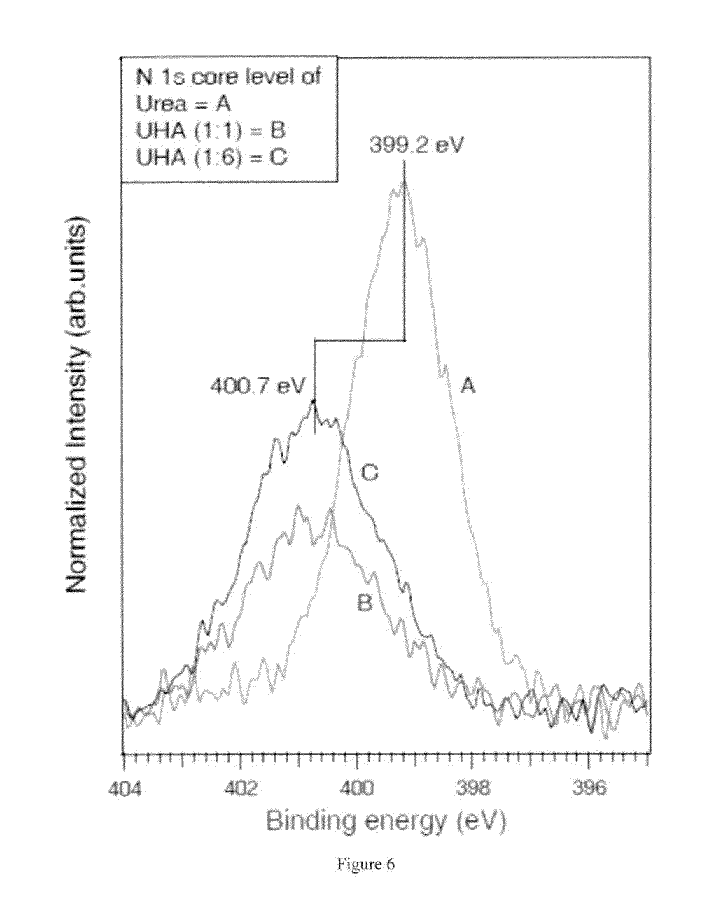

The nature of the bonding environment of the urea-HA nanocomposite (6:1) was studied using X-ray photoelectron spectroscopy (XPS). As shown in FIG. 6, a clear shift in the peak, position towards a higher binding energy can be observed in N 1s core level spectrum recorded for urea (spectrum A) when urea is attached to HA (spectra B and C), which demonstrates that the formation of a new bond between urea and HA through the N atom of urea. Further, there was no significant difference in the spectral line shape between urea-HA (1:1) and urea-HA (6:1) except for the peak intensity, thus indicating that the nature of the bonding between urea and HA in both composites is similar.

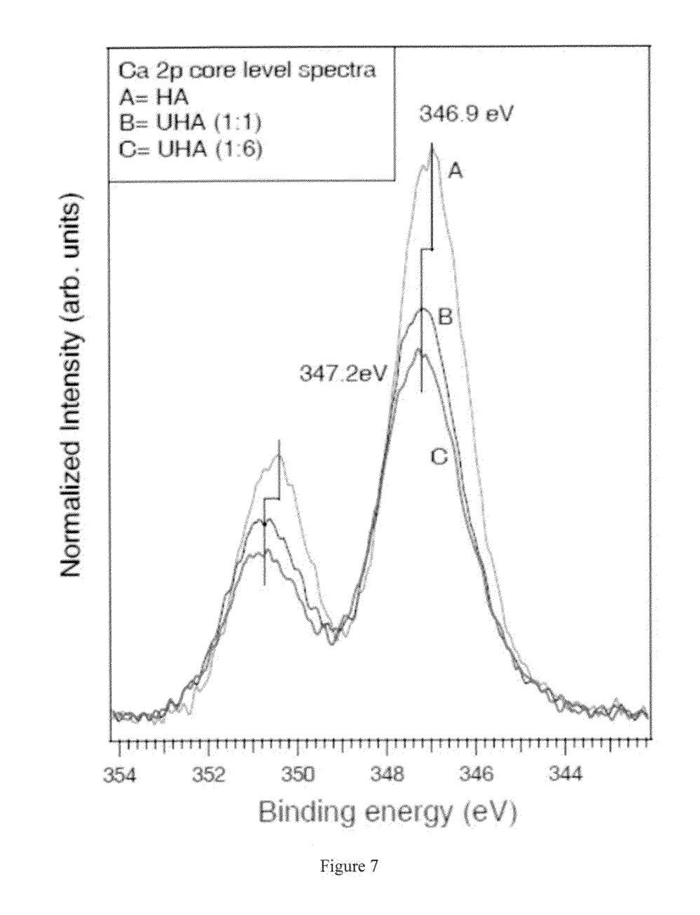

The XPS data for the Ca 2p core level spectra of HA and urea-HA nanocomposites shown in FIG. 7 also show a shift in the binding energy position towards a higher binding energy when HA is combined with urea. The shift in the binding energy of Ca 2p is significant for the urea-HA (6:1) nanocomposite, indicating that the chemical environment around Ca in the HA has been modified due to the presence of urea molecules. It is likely that N in urea binds to Ca in HA in this composite, and that the strength of the bonding could be stronger for the urea-HA (6:1) nanocomposite than for the urea-HA (1:1) nanocomposite.

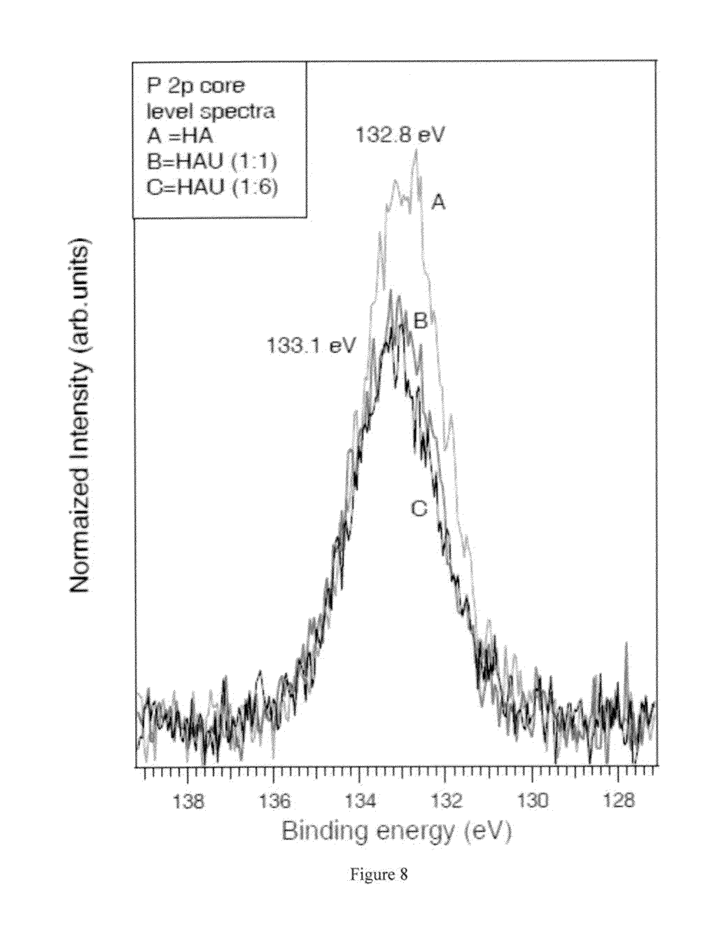

The XPS data for the P 2p core level spectra of HA and urea-HA nanocomposites are shown in FIG. 8. The doublet (2p_{1/2} and 2p_{3/2}) of the P 2p appear in this figure with lower resolution. A shift in the peak, of the P 2p core level of HA towards a higher binding energy is observed again when urea is introduced into the HA, indicating that the chemical atmosphere around P has been influenced by the introduction of urea into the system.

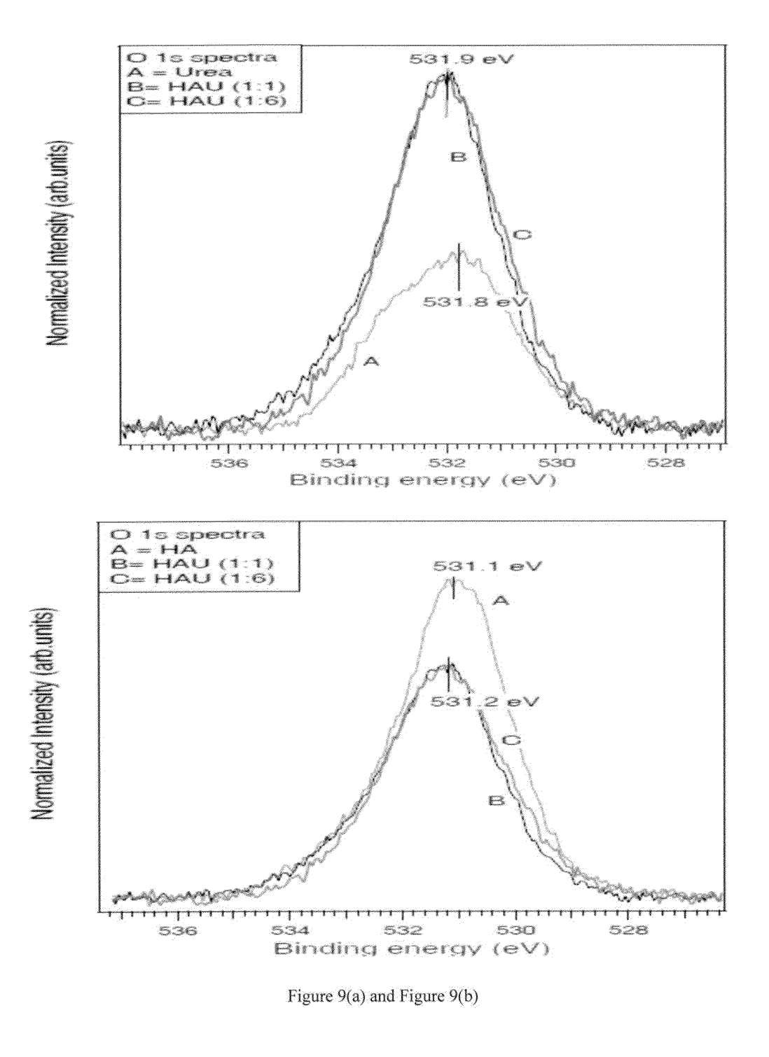

XPS data are shown for the O 1s core level using urea as the reference (FIG. 9(a)) and using HA as the reference (FIG. 9(b)). Upon mixing with HA, the O 1s spectrum of HA dominates the entire spectrum and almost all signals from the urea carbonyl have been masked. As a result, any changes in the urea carbonyl environment cannot be highlighted in the spectra when HA is used as the reference.

In the O 1s spectrum where HA is considered as the reference, the intensity and Full Width at Half Maximum (FWHM) has changed together with a slight change in the binding energy towards the higher binding direction when urea used as the reference material. This O 1s peak can be fitted to have two or three components as it is asymmetric and there is a tailing towards higher binding energy. This indicates that the HA nanoparticles contain oxygen with different chemical environments. The change in the chemical environment of oxygen after surface modification suggests the possibility of binding through oxygen of HA nanoparticles as well.

### Macronutrient Release Behavior in Water

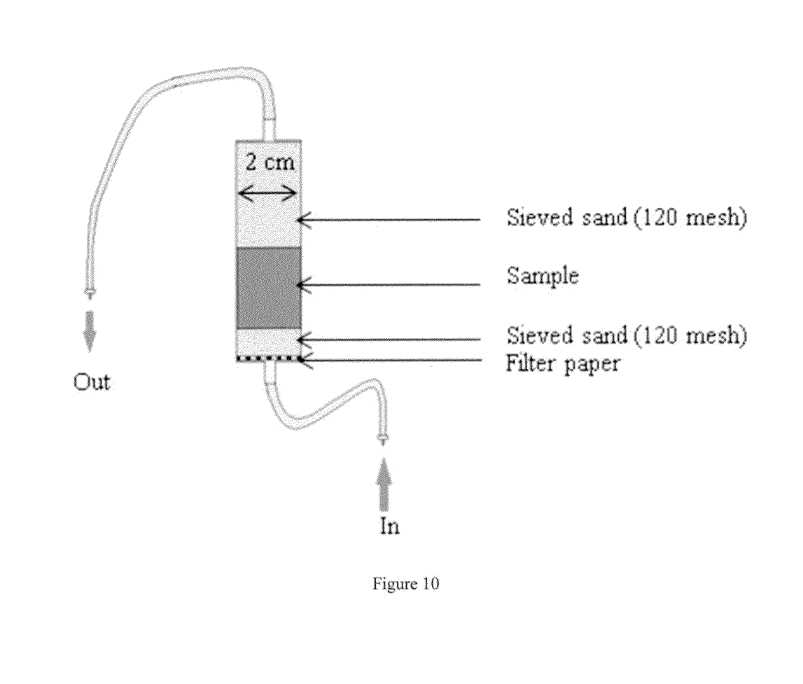

Sand (10.0 g) sieved through 500 μm and 200 μm meshes respectively was used for the dissolution behavior studies. Samples (each sample containing N amounts equivalent to that in 2.0 g of urea) was placed in between the sand column as shown in FIG. 10. Distilled water was then pumped from the bottom of the chamber at a rate of 3.75 ml/min and water that elutes was collected at 20 s intervals for the period of 40 min continuously.

Immediately after collecting, the samples were analyzed using FTIR and for the appearance of a urea peak in each sample: The peaks were normalized with respect to the O—H stretching frequency peak of water, which did not shift, and the area under the peak was analyzed for the N—C—N stretching frequency peak of urea.

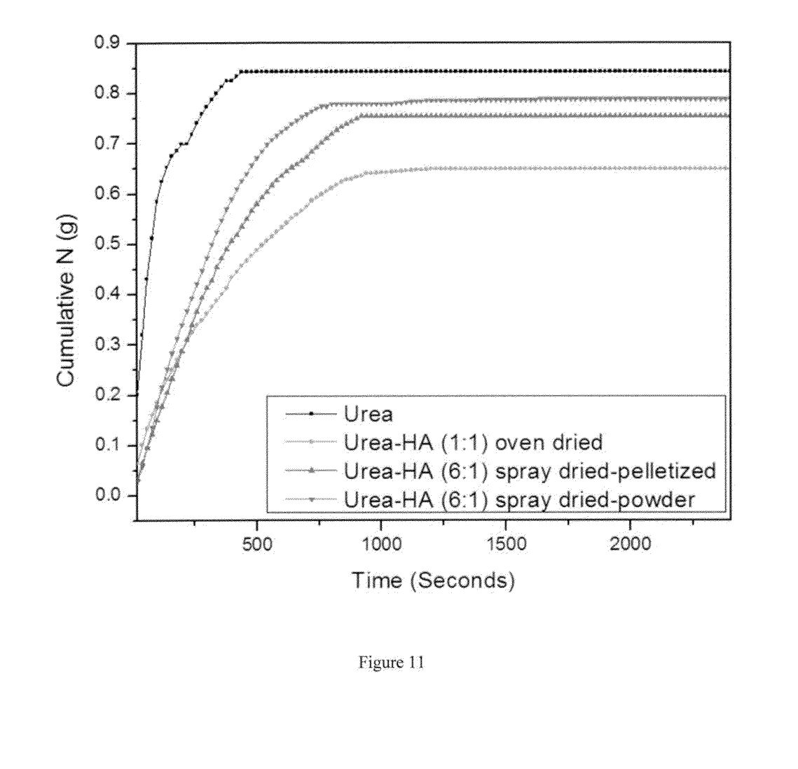

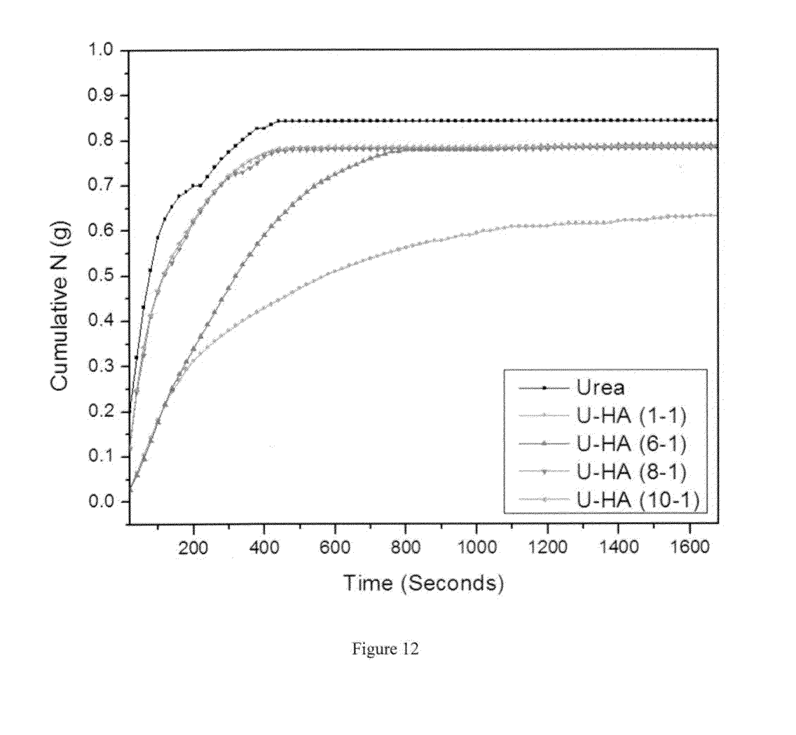

The release behavior of the samples in water is summarized in FIGS. 11 and 12.

With respect to FIG. 11, samples used for evaluating the release of urea (N) in water were:
1. Urea
2. Urea-HA (1:1) oven dried powder
3. Urea-HA (6:1) spray (flash) dried pellets
4. Urea-HA (6:1) spray (flash) dried powder

With reference to FIG. 11, a rapid release of urea in an aqueous medium was observed for urea when compared with both the urea-HA (6:1) spray dried powder and urea-HA (6:1) spray dried pellets at room temperature. Almost 100% of the total nitrogen in the urea-only sample was released before 500 see. The urea-HA (6:1) spray dried pellets released nitrogen in an exceptionally slow manner indicating a clear slow and sustained release. A steady state was reached around 1000 sec for urea-HA (6:1) spray dried pellets with a similar result for the urea-HA (6:1) spray dried powder. The slow release characteristics of the urea-HA pellets with 8:1 and 10:1 ratios of urea: HA did not demonstrate significant slow release compared to the urea: HA 6:1 formulation.

With respect to FIG. 12, samples used for evaluating the release of urea (N) in water were:
1. Urea
2. Urea-HA (1:1) oven dried powder
3. Urea-HA (6:1) spray (flash) dried pellets
4. Urea-HA (8:1) spray (flash) dried pellets
5. Urea-HA (10:1) spray (flash) dried pellets
   With reference to FIG. 12, similar results were obtained for the urea, the 1:1 urea: HA oven dried powder, and 6:1 spray dried pellets. The slow release characteristics of the urea-HA pellets with 8:1 and 10:1 ratios of urea: HA did not demonstrate significant slow release compared to the urea: HA 6:1 formulation.

### Release Behavior in Soils

The solid nitrogen-containing macronutrient-adsorbed HA nanoparticle composition described herein can be applied to the soil in the form of a powder, granules, pellets, or chips. In certain embodiments of the present invention, a slow release of nitrogen over a period up to three months is observed. During the application of fertilizer to tea plants, for example, the frequency of application can be attenuated depending on the fertilizer requirement of a given tea plantation. This can be done by slatting a second round of application at a suitable period prior to reaching the end of the viability of the first application of the macronutrient-adsorbed HA nanoparticles. In another embodiment, multiple applications of the macronutrient-adsorbed HA nanoparticles are distributed on soils within three months.

The macronutrient-adsorbed HA nanoparticles disclosed herein can be used for supplying macronutrients for crops such as tea; rubber; coconut; soybeans; cotton; tobacco; sugar cane; cereals such, as rice, corn (maize), sorghum, and wheat; fruits such as apples, oranges, and tomatoes; vegetables; ornamental plants; and other short term cash crops that grow in a range of pH soils.

As a person skilled in the art may recognize, soil pH plays a role in the release behavior of the macronutrients from the macronutrient-adsorbed HA nanoparticles to the soil. Further, soil pH is important in the growth of economic plants (rice, tea, and rubber) and ornamental plants (ferns and orchids). It is believed that high organic matter content in soil could lead to lowering of pH of the soil. Elevation may play a role in the effect. In general, higher elevations contain more organic matter compared to lower elevations such as sea level. Organic matter content of soil between 1600 to 4000 feet elevation in Sri Lanka can range from 2 to 3%. Generally, tea plants thrive in acidic soils in the pH range between about 4.2 to 5.7. However, rice is more tolerant of slightly higher pH with the ideal range being between about 5.0-6.0.

It is believed that, while not bound by theory, protonation of the macronutrient adsorbed HA nanoparticles leads to the release of the adsorbed macronutrient. Here, urea, due to its basicity, can be readily protonated, particularly in an acidic medium. This may aid the release process.

In an embodiment of the slow release method, soil having a pH of 5 found at about 1600 feet from tea plantations in Randy, Sri Lanka, can be used with macronutrient adsorbed HA nanoparticles to release the macronutrient in a slow and sustained manner. In another embodiment, soil with a pH 5.5-6.0 can be used with macronutrient adsorbed HA nanoparticles to slowly release the macronutrient. Even in sandy soils found at sea level pH 7, for example in Colombo, Sri Lanka, where the organic content is lower than 2%, the slow and sustained release may be achieved. To summarize, while slow release of macronutrient compound will occur in soils having a pH range of 3.5 to 7.00, soils having acidic pH values in the range between about 4.2-6.5 are most, preferred.

### Rice Pot Trials

The efficacy of the plant nutrient system based on the 6:1 urea-HA nanoparticle flash-dried formulation of an embodiment of the present invention was tested using a pot trial conducted with Oriza Sativa (rice) at the Rice Research and. Development Institute (RRDI) of Sri Lanka. Pots were tilled with 5 kg of soil unfertilized for 30 years and the rice variety BG 365 was used. The following treatments in Table 1 were applied in a completely randomized block design during a 14 week experimental period. For the purposes of the experiments described herein, the phrase “6:1 urea-HA nanoparticle composition” refers to the flash-dried urea-HA nanoparticle fertilizer of an embodiment of the present invention, wherein the ratio of urea:HA is about 6:1.

TABLE 1

| Treatment | Description of Treatment |
|---|---|
| T1 | No fertilizer. |
| T2 | A basal fertilizer treatment (2 weeks before distribution of seeds) of urea in the |
| | standard fertilizer dose (26.79 mg) was applied to the soil and then three top |
| | dressings (187.50 mg, 294.64 mg, and 133.93 mg) were applied to the soil at 2 |
| | weeks, 4 weeks, and 6 weeks, respectively after emergence of seeds. |
| T3 | A basal fertilizer treatment (2 weeks before distribution of seeds) of urea in 50% of |
| | the standard fertilizer dose (13.39 mg) was applied to the soil and three top dressings |
| | (93.75 mg, 147.32 mg, and 66.96 mg) were applied to the soil at 2 weeks, 4 weeks, |
| | and 6 weeks, respectively after emergence of seeds. |
| T4 | A basal fertilizer treatment (2 weeks before distribution of seeds) of urea in 25% of |
| | the standard fertilizer dose (6.70 mg) was applied to the soil and three top dressings |
| | (46.88 mg, 73.66 mg, and 33.48 mg) were applied to the soil at 2 weeks, 4 weeks, |
| | and 6 weeks, respectively after emergence of seeds. |
| T5 | A basal fertilizer treatment (2 weeks before distribution of seeds) of the 6:1 urea-HA |
| | nanoparticle composition in 50% of the standard fertilizer dose (387.70 mg) was |
| | applied to the soil. |
| T6 | A basal fertilizer treatment (2 weeks before distribution of seeds) of the 6:1 urea-HA |
| | nanoparticle composition in 50% of the standard fertilizer dose (193.85 mg) and one |
| | top dressing (193.85 mg) at 2 weeks after emergence were applied to the soil. |
| T7 | A basal fertilizer treatment (2 weeks before distribution of seeds) of the 6:1 urea-HA |
| | nanoparticle composition in 50% of the standard fertilizer dose (129.23 mg) and two |
| | top dressings (129.23 mg) and (129.23 mg) at 2 weeks and 4 weeks after emergence |
| | were applied to the soil. |
| T8 | A basal fertilizer treatment (2 weeks before distribution of seeds) of the 6:1 urea-HA |
| | nanoparticle composition in 25% of the standard fertilizer dose (193.85 mg) was |
| | applied to the soil. |
| T9 | A basal fertilizer treatment (2 weeks before distribution of seeds) of the 6:1 urea-HA |
| | nanoparticle composition in 25% of the standard fertilizer dose (96.92 mg) and one |
| | top dressing (96.93 mg) at 2 weeks after emergence were applied to the soil. |
| T10 | A basal fertilizer treatment (2 weeks before distribution of seeds) of the 6:1 urea-HA |
| | nanoparticle composition in 25% of the standard fertilizer dose (64.62 mg) and two |
| | top dressings (64.62 mg and 64.62 mg) at 2 weeks and 4 weeks after emergence |
| | were applied to the soil. |

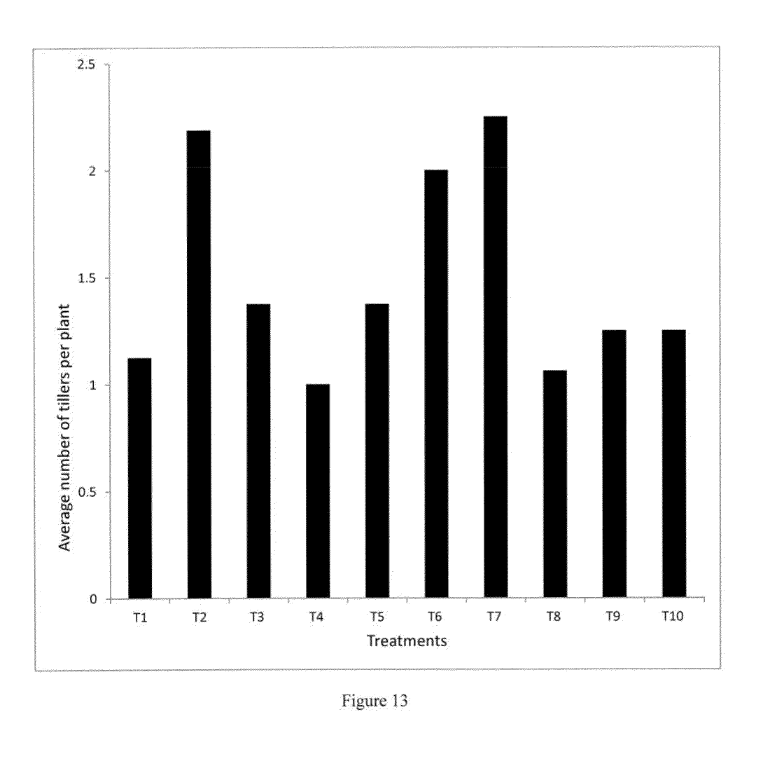

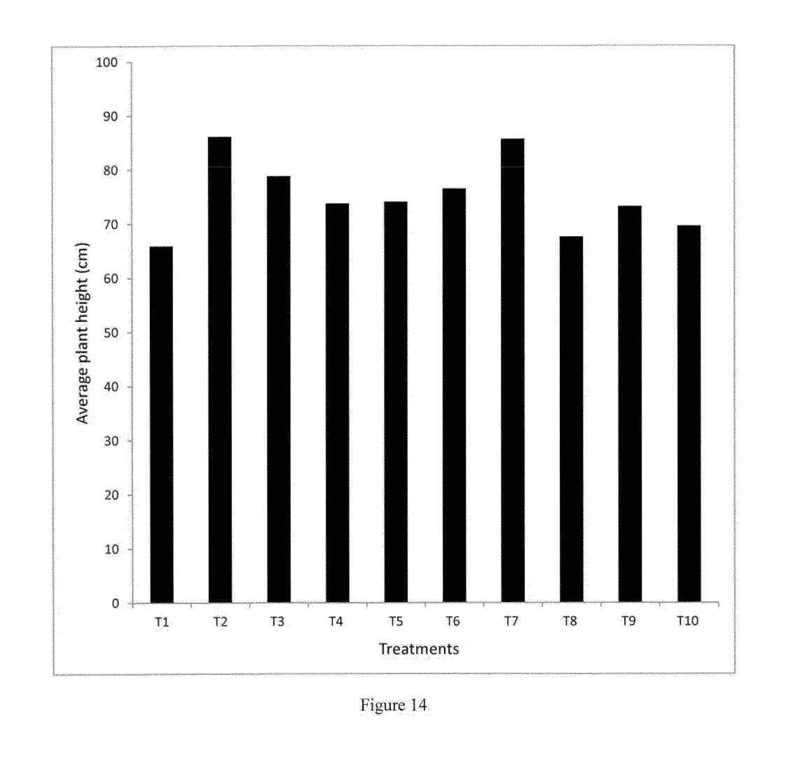

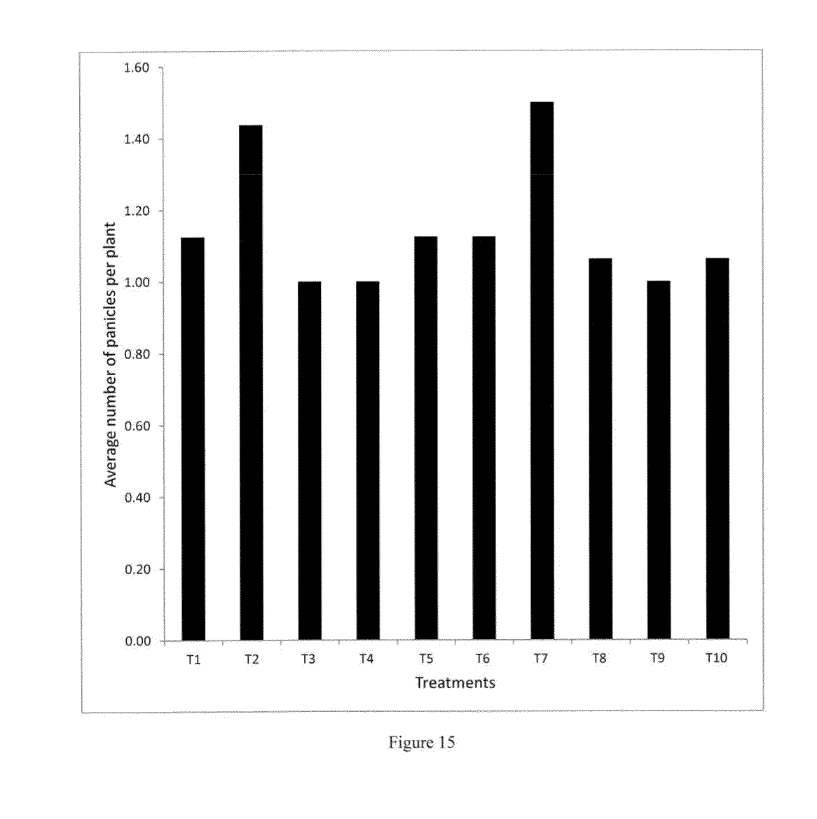

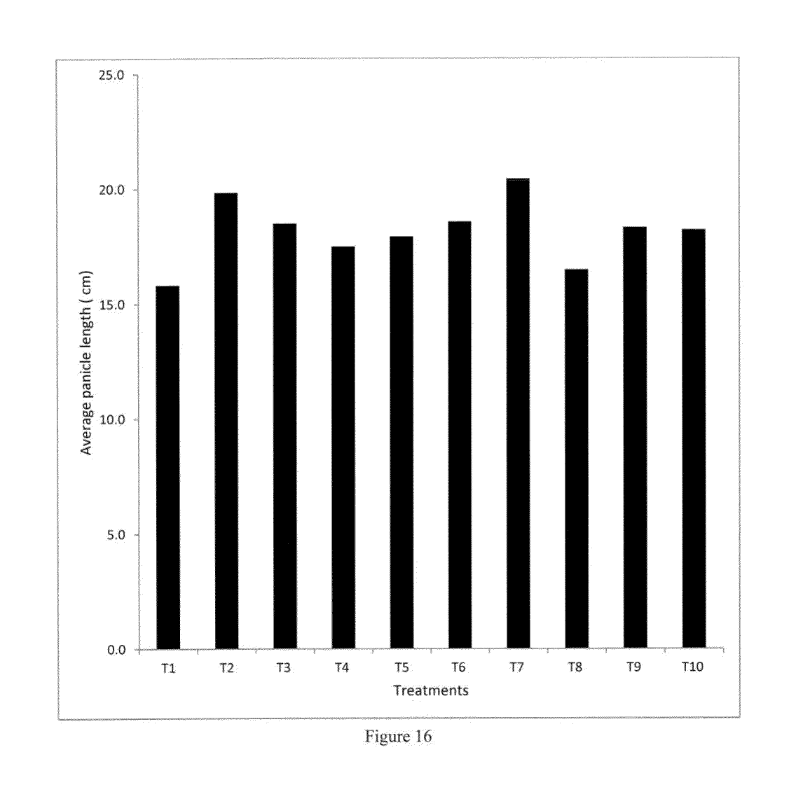

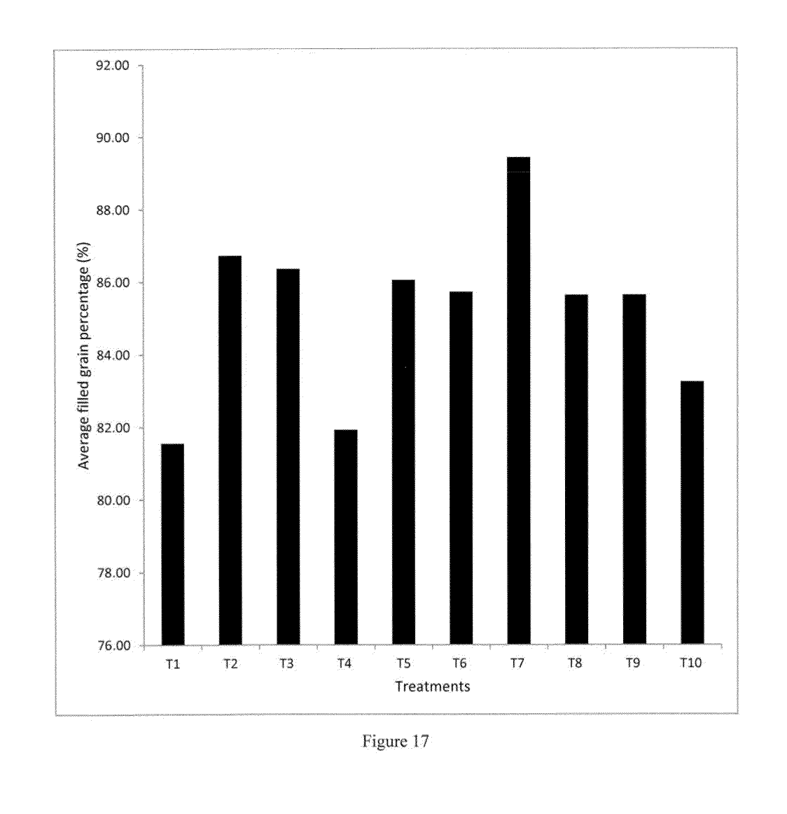

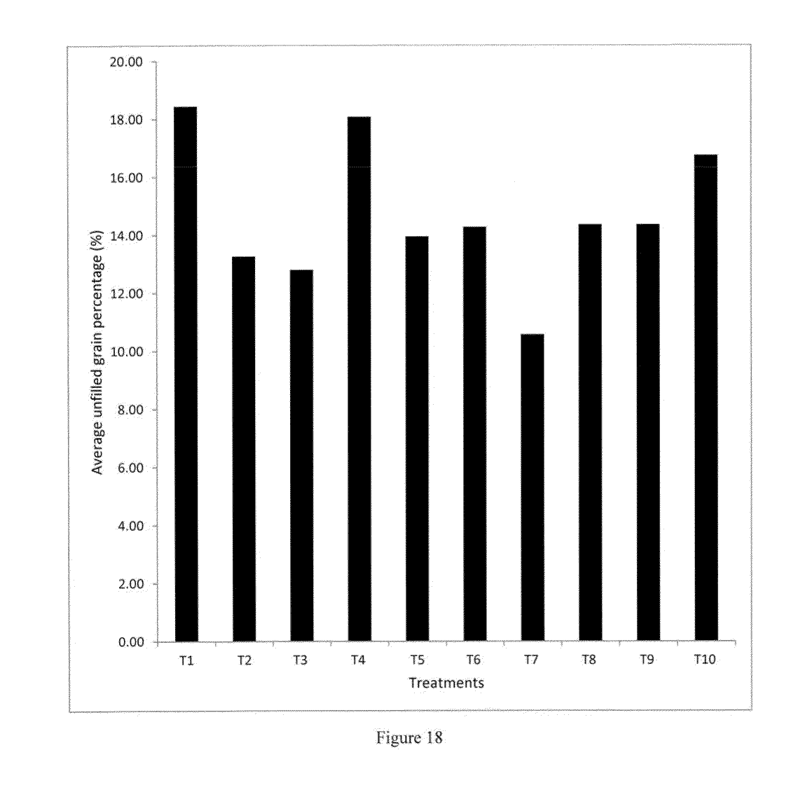

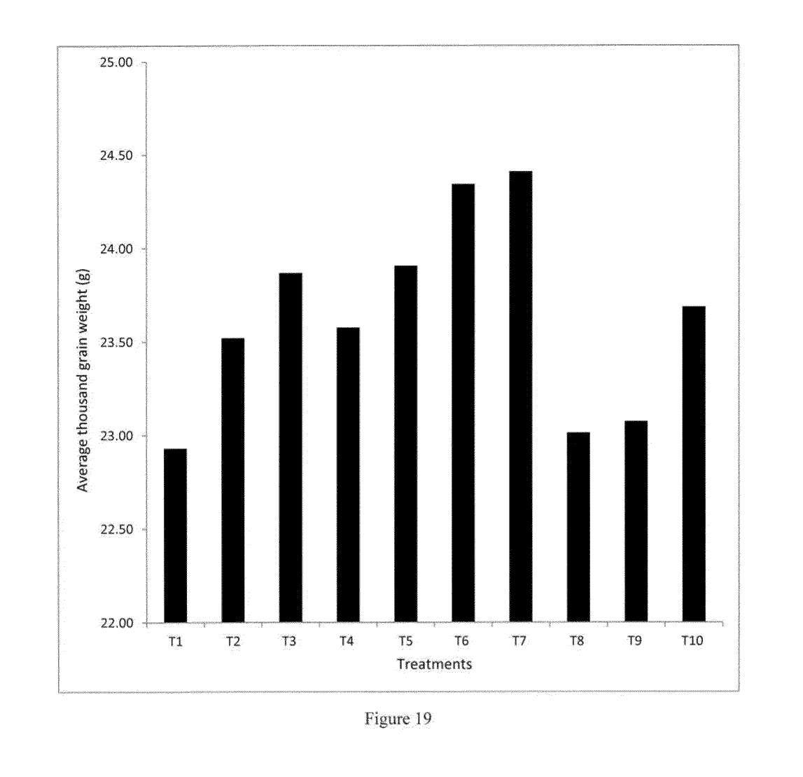

In all treatments the phosphorous and potassium amounts were added in the following respective amounts: 222.22 mg and 83.33 mg. The average number of tillers per plant, plant height, number of panicles per plant, panicle lengths per plant, average filled grain weight, average unfilled grain weight and thousand grain weights were recorded and summarized in Tables 2-8 and FIGS. 13-19.

TABLE 2
Number of tillers for treamtents T1-T10

| | Average number of |
|---|---|
| Treatment | tillers per plant |
| T1 | 1.12 |
| T2 | 2.19 |
| T3 | 1.38 |
| T4 | 1.00 |
| T5 | 1.38 |
| T6 | 2.00 |
| T7 | 2.25 |
| T8 | 1.06 |
| T9 | 1.25 |
| T10 | 1.25 |

TABLE 3
Plant height at the end of 14 weeks
after emergence for treatments T1-T10

| | Average plant height |
|---|---|
| Treatment | (cm) |
| T1 | 65.9 |
| T2 | 86.1 |
| T3 | 78.8 |
| T4 | 73.8 |
| T5 | 74.1 |
| T6 | 76.5 |
| T7 | 85.7 |
| T8 | 67.6 |
| T9 | 73.2 |
| T10 | 69.6 |

TABLE 4
Number of panicles per plant for treatments T1-T10

| | Average number of |
|---|---|
| Treatment | panicles per plant |
| T1 | 1.13 |
| T2 | 1.44 |
| T3 | 1.00 |
| T4 | 1.00 |
| T5 | 1.13 |
| T6 | 1.13 |
| T7 | 1.50 |
| T8 | 1.06 |
| T9 | 1.00 |
| T10 | 1.06 |

TABLE 5
Average panicle length for treatments T1-T10

| | Average panicle length |
|---|---|
| Treatment | (cm) |
| T1 | 15.8 |
| T2 | 19.8 |
| T3 | 18.5 |
| T4 | 17.5 |
| T5 | 17.9 |
| T6 | 18.6 |
| T7 | 20.4 |
| T8 | 16.5 |
| T9 | 18.3 |
| T10 | 18.2 |

TABLE 6
Filled grain percentage for treatments T1-T10

| | Average filled grain |
|---|---|
| Treatment | percentage |
| T1 | 81.56 |
| T2 | 81.73 |
| T3 | 86.36 |
| T4 | 81.92 |
| T5 | 86.05 |
| T6 | 85.73 |
| T7 | 89.43 |
| T8 | 85.64 |
| T9 | 85.64 |
| T10 | 83.25 |

TABLE 7
Unfilled grain percentage for treatment T1-T10

| | Average unfilled grain |
|---|---|
| Treatment | percentage |
| T1 | 18.44 |
| T2 | 13.27 |
| T3 | 12.80 |
| T4 | 18.08 |
| T5 | 13.95 |
| T6 | 14.27 |
| T7 | 10.57 |
| T8 | 14.36 |
| T9 | 14.36 |
| T10 | 16.75 |

TABLE 8
Thousand grain weight for treatments T1-T10

| | Average thousand |
|---|---|
| Treatment | grain weight (g) |
| T1 | 22.93 |
| T2 | 23.52 |
| T3 | 23.87 |
| T4 | 23.58 |
| T5 | 23.91 |
| T6 | 24.34 |
| T7 | 24.41 |
| T8 | 23.01 |
| T9 | 23.08 |
| T10 | 23.69 |

Out of all the treatments described in the experiments detailed above, the treatments (6 and 7) of 50% of the standard fertilizer amount with 2 top dressings using the flash-dried urea-HA nanoparticle fertilizer of an embodiment of the present invention, wherein the ratio of urea:HA was about 6:1, displayed the best properties in terms of yield and quality (lower amounts of unfilled grains).

1. A solid fertilizer composition comprising a nitrogen-containing macronutrient adsorbed on the surface of hydroxyapatite phosphate nanoparticles, wherein in at least a portion of solid fertilizer composition, the ratio of said nitrogen-containing macronutrient to hydroxyapatite phosphate is between about 1:1 and about 6:1.

2. The solid fertilizer composition of claim 1 wherein the nitrogen-containing macronutrient is urea.

3. A method of preparing a solid, sustained release fertilizer composition comprising:
(a) preparing an aqueous Ca(OH)₂ and nitrogen-containing macronutrient dispersion;
(b) adding phosphoric acid to said aqueous dispersion to form a urea-HA nanoparticle dispersion; and
(e) flash drying said nanoparticle dispersion.

4. The method of claim 4 wherein the nitrogen-containing macronutrient is urea.

5. The method of claim 4 wherein said flash drying comprises spraying said nanoparticle dispersion onto a hot surface.

6. The method of claim 4 wherein said flash drying comprises spraying said nanoparticle dispersion through a hot countercurrent air flow.

7. A method of slowly releasing macronutrient to a plant locus comprising: applying to soil a solid nanocomposite having a nitrogen-containing macronutrient compound adsorbed on the surface of hydroxyapatite phosphate nanoparticles wherein in at least a portion, of said nanocomposite the ratio of said nitrogen-containing macronutrient compound to hydroxyapatite phosphate is between about 1:1 and about 6:1.

8. The method of claim 7 wherein said nitrogen-containing macronutrient compound is urea.

9. The method of claim 7 further comprising contacting said nanocomposite with the soil more than once within a period of three months.

10. The method of claim 7 wherein the plant locus comprises a tea plant locus.

11. The method of claim 7 wherein the plant locus comprises a rice plant locus,

12. The method of claim 7 wherein the plant locus comprises a rubber plant locus.

13. The method of claim 7 wherein the plant locus comprises a coconut plant locus.

14. The method of claim 7 wherein the plant locus comprise a corn (maize) plant locus.

15. The method of claim 7 wherein, the plant locus comprises a short term cash crop.

16. The method of claim wherein the soil has a pH range between 4.2 to 6.5.

17. A solid fertilizer composition comprising a nitrogen-containing macronutrient adsorbed on the surface of hydroxyapatite phosphate, wherein in at least a portion of solid fertilizer composition, the ratio of nitrogen-containing macronutrient to hydroxyapatite phosphate is between about 6:1 and about 10:1.

18. The solid fertilizer composition of claim 17 wherein the nitrogen-containing macronutrient is urea.
